(19) United States
(12) Patent Application Publication
(10) Pub. No.: US 2026/0200485 A1
(43) Pub. Date: Jul. 16, 2026

(54) EMERGENCY CONTROL SYSTEM AND METHOD FOR A STEER-BY-WIRE SYSTEM

(71) Applicants: HYUNDAI MOTOR COMPANY, Seoul (KR); KIA CORPORATION, Seoul (KR)

(72) Inventor: Dongchang Li, Yantai (CN)

(73) Assignees: HYUNDAI MOTOR COMPANY, Seoul (KR); KIA CORPORATION, Seoul (KR)

(21) Appl. No.: 19/447,716

(22) Filed: Jan. 13, 2026

(30) Foreign Application Priority Data
Jan. 16, 2025 (CN) 202510072043.9

(51) Int. Cl. B60W 50/029; B60W 10/18; B60W 10/20; B60W 30/09; B60W 30/095; B60W 30/16; B60W 30/18; B60W 50/02; B60W 50/14; B60W 60/00

(52) U.S. Cl. CPC B60W 50/029; B60W 10/18; B60W 10/20; B60W 30/09; B60W 30/0953; B60W 30/0956; B60W 30/16; B60W 30/18163; B60W 50/0205; B60W 50/14; B60W 60/0015; B60W 2050/143; B60W 2520/10; B60W 2552/10; B60W 2554/802; B60W 2554/804; B60W 2555/60; B60W 2720/10

(57) ABSTRACT

An emergency control system for a vehicle, the emergency system being configured to operate in response to a failure of a steer-by-wire (SBW) system of the vehicle is provided. The SBW system includes a steering force actuator connected to a steering wheel and a wheel drive and performs communication between the steering force actuator and the wheel drive to control wheel steering through the steering wheel. The emergency control system includes at least one sensor to detect information relating to the vehicle and information on surroundings of the vehicle, an acceleration/deceleration device to control a vehicle speed, an emergency autonomous driving control device to execute a vehicle lane change assist control, a lane following assist control, and a forward collision-avoidance assist control, and a controller.

### CROSS-REFERENCE TO RELATED APPLICATION

This application claims priority to and the benefit of Chinese Patent Application No. 202510072043.9 under 35 U.S.C. § 119, filed on Jan. 16, 2025, in the Chinese National Intellectual Property Administration, the entire contents of which are incorporated herein by reference.

### FIELD

The present disclosure generally relates to the field of the vehicle automatic control.

### BACKGROUND

A vehicle steering system refers to a system that changes the steering angle of the wheels based on the steering force applied to the steering wheel by the driver. In related technology, a steer-by-wire (SBW) system eliminates the mechanical connection between a steering wheel and front wheels of the vehicle and can control steering of the front wheel based on electrical signals generated by the rotation of the steering wheel. The SBW system includes a steering force actuator (SFA) and a road wheel actuator (RWA). The SFA is connected to the steering wheel manipulated by the driver, and the RWA is connected to the wheel on which the actual steering is performed. The SFA and the RWA communicate with each other through electric signals. For example, the SFA and the RWA may be interconnected through a controller area network (CAN) bus.

The above information disclosed in this Background section is only for enhancement of understanding of the background of the disclosure, and therefore, it may contain information that does not form the prior art that is already known to a person of ordinary skill in the art.

### SUMMARY

According to one aspect of the present disclosure, an emergency control system and emergency control method in a case of a failure of an SFA of a steer-by-wire (SBW) system is provided.

According to another embodiment of the present disclosure, an emergency control system for a vehicle, the emergency system being configured to operate in response to a failure of a steer-by-wire (SBW) system of the vehicle is provided. The SBW system may include a steering force actuator connected to a steering wheel and a wheel drive and perform communication between the steering force actuator and the wheel drive to control wheel steering through the steering wheel. The emergency control system may include at least one sensor configured to detect information relating to the vehicle and information on surroundings of the vehicle, an acceleration/deceleration device configured to control a vehicle speed, an emergency autonomous driving control device configured to execute a vehicle lane change assist control, a lane following assist control, and a forward collision-avoidance assist control, and a controller. The controller may be configured to execute the lane following assist control and the forward collision-avoidance assist control using the emergency autonomous driving control device, when a target failure of the steering force actuator is detected, determine a target speed of the vehicle based on the information detected by the at least one sensor, and control the acceleration/deceleration device so that the vehicle drives at the target speed, determine whether a stopping condition is satisfied based on the information detected by the at least one sensor, and control the acceleration/deceleration device, when the stopping condition is satisfied.

The controller may be configured to determine whether a relative distance between the vehicle and a rear object is greater than or equal to a predetermined safety distance, while determining the target speed of the vehicle, preemptively determine the target speed as a predetermined safety speed, when the relative distance between the vehicle and the rear object is greater than or equal to the predetermined safety distance, and determine whether the predetermined safety speed is greater than a speed of a front object. The controller may be configured to finally determine the target speed as the predetermined safety speed, when the predetermined safety speed is smaller than or equal to the speed of the front object, finally set the target speed to be smaller than or equal to the speed of the front object, when the predetermined safety speed is greater than the speed of the front object, and set the target speed of the vehicle to be greater than or equal to a speed of the rear object and smaller than or equal to the speed of the front object, when the relative distance between the vehicle and the rear object is smaller than the predetermined safety distance.

The controller may be configured to determine whether an object approaching a rear side of the vehicle in a predetermined distance in a speed is greater than a high-speed threshold, while determining whether the stopping condition is satisfied, and determine that a condition for stopping the vehicle in a current driving lane is satisfied, when the object approaching the rear side of the vehicle in the predetermined distance in the speed greater than the high-speed threshold does not exist. The controller is configured to determine whether the current driving lane of the vehicle is an outermost lane, and determine that a condition for stopping the vehicle in the outermost lane of the current driving lane is satisfied, when the current driving lane of the vehicle is not the outermost lane. The controller is configured to determine that the stopping condition is satisfied, when one condition of the condition for stopping the vehicle in the current driving lane and the condition for stopping the vehicle in the outermost lane of the current driving lane is satisfied.

The controller may be configured to output information to ask whether to stop the vehicle in the current driving lane or whether to stop the vehicle in the outermost lane of the current driving lane, when the condition for stopping the vehicle in the current driving lane and the condition for stopping the vehicle in the outermost lane of the current driving lane is all satisfied. The controller is configured to turn off the lane following assist control of the emergency autonomous driving control device, turn on the lane change assist control, perform a lane change of the vehicle once or more time using the lane change assist control based on the information detected by the at least one sensor, and stop the vehicle by controlling the acceleration/deceleration device after the vehicle has lane-changed to the outermost lane, when an instruction to stop the vehicle in the outermost lane of the current driving lane is received, or when only the condition for stopping the vehicle in the outermost lane of the current driving lane is satisfied. The controller is configured to stop the vehicle in the current driving lane by controlling the acceleration/deceleration device, when an instruction to stop the vehicle in the current driving lane is received, or when only the condition for stopping the vehicle in the current driving lane is satisfied.

The information of the vehicle may include speed and acceleration of the vehicle, and a position of a current driving lane of the vehicle.

The information on the surroundings of the vehicle may include a relative distance and relative speed between a nearby object and the vehicle, positions of lanes, a number of lanes on a road, and a speed limit of the road. The information on the surroundings of the vehicle may further include whether there is a shoulder or a roadside fence and a position relationship between the shoulder or the roadside fence and a current driving lane of the vehicle.

The target failure of the steering force actuator may include at least a steering angle sensor failure, a steering force actuator power failure, and a communication failure between the steering force actuator and a CAN bus.

The controller may be configured to detect the target failure of the steering force actuator, when a diagnostic trouble code is received from the SBW system, and the received diagnostic trouble code represents a steering force actuator failure, while detecting the target failure of the steering force actuator.

The emergency control system may further include a failure alarming device, where the controller may be configured to send an alarm to a driver and an outside of the vehicle by controlling the failure alarming device, when the target failure of the steering force actuator is detected.

The emergency control system may further include a human-computer interaction interface device, where the controller may be configured to transmit a steering force actuator failure message by controlling the human-computer interaction interface device, when the target failure of the steering force actuator is detected, obtain a control instruction of a driver by controlling the human-computer interaction interface device, when it is determined that a condition for stopping the vehicle in a current driving lane and a condition for stopping the vehicle in an outermost lane of the current driving lane are all satisfied, and transmit a message to exit the vehicle by controlling the human-computer interaction interface device, when the vehicle stops.

According to another embodiment of the present disclosure, an emergency control method for a vehicle, the emergency system being configured to operate in response to a failure of a steer-by-wire (SBW) system of the vehicle is provided, wherein the SBW system may include a steering force actuator connected to a steering wheel and a wheel drive and perform communication between the steering force actuator and the wheel drive to control wheel steering through the steering wheel. The emergency control method may include executing a lane following assist control and a forward collision-avoidance assist control, when a target failure of the steering force actuator is detected, determining a target speed of the vehicle based on information of the vehicle and information on surroundings of the vehicle, controlling the vehicle to drive at the target speed, determining whether a stopping condition is satisfied based on the information of the vehicle and the information on the surroundings of the vehicle, and executing a vehicle stopping operation, when the stopping condition is satisfied.

The determining of the target speed of the vehicle may include determining whether a relative distance between the vehicle and a rear object is greater than or equal to a predetermined safety distance, preemptively determining the target speed as a predetermined safety speed, when the relative distance between the vehicle and the rear object is greater than or equal to the predetermined safety distance, and determining whether the predetermined safety speed is greater than a speed of a front object. The determining of the target speed of the vehicle may further include finally determining the target speed as the predetermined safety speed, when the predetermined safety speed is smaller than or equal to the speed of the front object, finally setting the target speed to be smaller than or equal to the speed of the front object, when the predetermined safety speed is greater than the speed of the front object, and setting the target speed of the vehicle to be greater than or equal to a speed of the rear object and smaller than or equal to the speed of the front object, when the relative distance between the vehicle and the rear object is smaller than the predetermined safety distance.

The determining of whether the stopping condition is satisfied may include determining whether an object approaching a rear side of the vehicle in a predetermined distance in a speed is greater than a high-speed threshold, and determining whether a current driving lane of the vehicle is an outermost lane, determining that a condition for stopping the vehicle in the current driving lane is satisfied, when the object approaching the rear side of the vehicle in the predetermined distance in the speed greater than the high-speed threshold does not exist. The determining of whether the stopping condition is satisfied may further include determining that a condition for stopping the vehicle in the outermost lane of the current driving lane is satisfied, when the current driving lane of the vehicle is not the outermost lane, and determining that the stopping condition is satisfied, when one condition of the condition for stopping the vehicle in the current driving lane and the condition for stopping the vehicle in the outermost lane of the current driving lane is satisfied.

The executing of the stopping operation of the vehicle may include outputting information to ask whether to stop the vehicle in the current driving lane or whether to stop the vehicle in the outermost lane of the current driving lane, when the condition for stopping the vehicle in the current driving lane and the condition for stopping the vehicle in the outermost lane of the current driving lane is all satisfied. The executing of the stopping operation of the vehicle may further include turning off the lane following assist control, turning on a lane change assist control, performing a lane change of the vehicle once or more time using the lane change assist control based on the information of the vehicle and the information on the surroundings of the vehicle, and stopping the vehicle after the vehicle has lane-changed to the outermost lane, when an instruction to stop the vehicle in the outermost lane of the current driving lane is received, or when only the condition for stopping the vehicle in the outermost lane of the current driving lane is satisfied. The executing of the stopping operation of the vehicle may further include stopping the vehicle in the current driving lane, when an instruction to stop the vehicle in the current driving lane is received, or when only the condition for stopping the vehicle in the current driving lane is satisfied.

The information of the vehicle may include speed and acceleration of the vehicle, and a position of a current driving lane of the vehicle.

The information on the surroundings of the vehicle may include a relative distance and relative speed between a nearby object and the vehicle, positions of lanes, a number of lanes on a road, and a speed limit of the road. The information on the surroundings of the vehicle may further include whether there is a shoulder or a roadside fence and a position relationship between the shoulder or the roadside fence and a current driving lane of the vehicle.

The target failure of the steering force actuator may include at least a steering angle sensor failure, a steering force actuator power failure, and a communication failure between the steering force actuator and a CAN bus.

The detecting of the target failure of the steering force actuator may include detecting the target failure of the steering force actuator, when a diagnostic trouble code is received and the received diagnostic trouble code represents a steering force actuator failure.

The emergency control method may further include sending an alarm to a driver and an outside of the vehicle, when the target failure of the steering force actuator is detected.

The emergency control method may further include transmitting a steering force actuator failure message, when the target failure of the steering force actuator is detected, obtaining a control instruction of the driver, when it is determined that a condition for stopping the vehicle in a current driving lane and a condition for stopping the vehicle in an outermost lane of the current driving lane are all satisfied, and transmitting a message to exit the vehicle, when the vehicle stops.

In addition, the effects that may be obtained or expected from the embodiments of the present disclosure will be directly or implicitly disclosed in the detailed description of the present disclosure. In particular, various effects expected from the embodiments of the present disclosure will be described in the following detailed description.

### BRIEF DESCRIPTION OF THE DRAWINGS

Hereinafter, an embodiment of the present disclosure will be described in detail, with reference to the drawings. For clarity, like components in different figures are denoted by like reference numerals. It should be noted that the drawings are merely schematic and are not drawn to scale.

FIG. 1 is a schematic block diagram of an emergency control system in case of a failure of an SBW system according to an embodiment of the present disclosure.

FIG. 2A and FIG. 2B are schematic flowcharts of an emergency control method in the case of a failure of an SBW system according to an embodiment of the present disclosure.

### DETAILED DESCRIPTION

Hereinafter, exemplary embodiments of the present disclosure are described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements is omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless particularly stated otherwise.

In the present disclosure, the terms first, second, etc. are only used to distinguish one element from another and do not limit the order or the degree of importance between the elements unless particularly mentioned. Accordingly, a first element in an embodiment could be termed a second element in another embodiment, and, similarly, a second element in an embodiment could be termed a first element in another embodiment, without departing from the scope of the present disclosure.

The terms used herein to describe embodiments of the present disclosure is not intended to limit the scope of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It will be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

In the present disclosure, elements that are distinguished from each other are for clearly describing each feature, and do not necessarily mean that the elements are separated. In particular, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present disclosure and the way of attaining them will become apparent with reference to embodiments described below in detail in conjunction with the accompanying drawings. Embodiments, however, may be embodied in many different forms and should not be constructed as being limited to example embodiments set forth herein. Rather, these embodiments are provided so that this disclosure will be complete and will fully convey the scope of the invention to those skilled in the art.

In the present disclosure, each of phrases such as “A or B”, “at least one of A and B”, “at least one of A or B”, “A, B or C”, “at least one of A, B and C”, “”at Each of the phrases such as “at least one of A, B or C” and “at least one of A, B, C or combination thereof” may include any one or all possible combinations of the items listed together in the corresponding one of the phrases.

In addition to allowing the driver to control the vehicle driving, the vehicle may also execute emergency autonomous driving. A lane following assist (LFA) module and an automatic lane change (ALC) module of the vehicle Included in a vehicle autonomous driving system may generate a torque command, and a target steering angle control signal determined based on the torque command may be transmitted to a road wheel actuator (RWA). Similarly, the RWA controls the position of a rack based on the target steering angle control signal, to enable the vehicle to maintain a current lane or change the lane of the vehicle.

In particular, since a failure of a steering force actuator (SFA) does not affect the LFA module and the ALC module's control of the RWA, the safety can be secured by converting the vehicle into an emergency autonomous driving mode in the case of an SFA failure. Based on this point, the present disclosure provides an emergency control system and an emergency control method in case of a failure of an SBW system (particularly, the SFA failure).

Hereinafter, one or more embodiments of the present disclosure are described with reference to the accompanying drawings.

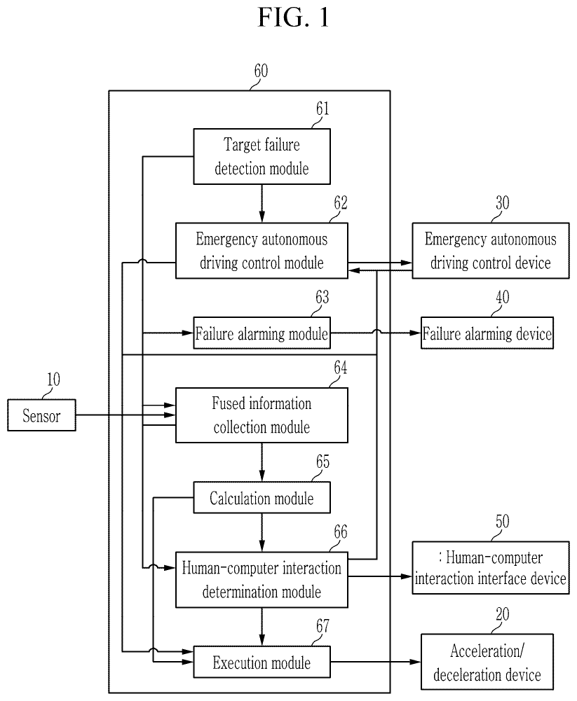

FIG. 1 is a schematic block diagram of an emergency control system in case of a failure of an SBW system according to an embodiment of the present disclosure. According to an embodiment of the present disclosure, an emergency control system in case of a failure of an SBW system may include a sensor 10, an acceleration/deceleration device 20, an emergency autonomous driving control device 30, a failure alarming device 40, a human-computer interaction interface device 50, and a controller 60.

The sensor 10 may be configured detect information of the vehicle and information on the surroundings of the vehicle.

In more detail, the information of the vehicle may include a speed and acceleration of the vehicle, and a position of a current driving lane of the vehicle. In this case, the sensor 10 may include a vehicle speed sensor detecting the vehicle speed and an acceleration sensor detecting the acceleration of the vehicle. In addition, the sensor 10 may include a camera capturing an image of the surroundings of the vehicle, and the camera may detect the position of the current driving lane of the vehicle using the captured road image.

The information on the surroundings of the vehicle may include a relative distance and relative speed between a nearby (or adjacent) object (e.g., vehicles, pedestrians, bicycles, motorcycles, or the like) and the vehicle. In this case, the camera may detect the nearby object using the captured image of the surroundings of the vehicle. The sensor 10 may further include a radio detection and ranging (RADAR) sensor. Particularly, the RADAR sensor may be a millimeter wave RADAR sensor and a laser RADAR sensor. The RADAR sensor may emit electromagnetic waves in all directions of the surroundings of the vehicle and receive electromagnetic waves reflected by nearby objects, to measure the relative distance and relative speed between the vehicle and the nearby object. Based on the vehicle speed and the relative speed between the vehicle and the nearby object, a speed of the nearby object may be additionally calculated.

In addition, the information on the surroundings of the vehicle may further include road information of the current driving lane of the vehicle. Particularly, road information of the current driving lane of the vehicle may include positions of lanes, the number of lanes on the road and a speed limit of the road. In this case, the camera may detect positions of lanes and the number of lanes using the captured road image, and the camera may detect speed limits of lanes using a captured image of a speed limit sign board.

In addition, road information of the current driving lane of the vehicle may further include whether there is a shoulder or a roadside fence and a position relationship between the shoulder or the roadside fence and the current driving lane of the vehicle. In this case, the camera may detect whether there is the shoulder or the roadside fence on a roadside of the current driving lane of the vehicle using the captured image of the road and roadside. When it is detected that there is the shoulder or the roadside fence, the camera may using the captured image of the road and roadside, to further detect the existing position relationship between the shoulder or the roadside fence and the current driving lane of the vehicle. For example, when it is detected by the camera that the existing shoulder or roadside fence is located on a right side of the current driving lane of the vehicle, this may indicate that the current driving lane of the vehicle is an outermost lane.

The acceleration/deceleration device 20 may be configured to control the vehicle speed. Particularly, the acceleration/deceleration device 20 may be implemented as at least one of a brake-by-wire (BBW) controller, a vehicle control unit (VCU), an electronic parking brake (EPB) controller, or a steer-by-wire (SBW) controller. Particularly, the BBW controller may execute a deceleration operation of the vehicle. The VCU may maintain a vehicle speed at a specific value by controlling a vehicle power system. In special situation, when the vehicle decelerates to the speed of 0 (i.e., to the parked state), the EPB controller may by controlling a parking brake motor of the vehicle, to execute the parking operation, and the SBW controller may control a vehicle gear to the P gear.

The emergency autonomous driving control device 30 may be configured to execute an automatic lane change (ALC) control, a lane following assist (LFA) control, and a forward collision-avoidance assist (FCA) control of the vehicle. Particularly, the emergency autonomous driving control device 30 may include the ALC module, the LFA module, and the FCA module, and realize a corresponding control. The ALC module may change the lane of the vehicle, the LFA module may enable the vehicle to maintain the current driving lane while driving, and the FCA module may execute an emergency braking when a forward collision risk exists.

The failure alarming device 40 may include a vehicle illumination controller, a horn controller, and a failure information transmission module. The vehicle illumination controller may control a left-and-right signal lamp outside the vehicle to blink, the horn controller may control the horn to sound, and the failure information transmission module may transmit the failure information to a platform outside the vehicle, to notify accident rescue personnel and/or vehicle maintenance personnel.

The human-computer interaction interface device 50 may be configured to exchange information between the user (or driver) and the vehicle. The manner in which the user inputs data into the vehicle may include a touch screen and voice recognition. However, it is not limited thereto. Thus, any method of input may be used. When the input method uses touching of a touch screen, the user may input a manipulation on the vehicle by touching an icon displayed in the touch screen. When the input method uses a voice recognition, the vehicle may input the manipulation of the vehicle by recognizing the user by the voice of the user. The manner in which the vehicle outputs data to the user may include image output and voice output, and the image may include text images, 2D/3D animation images, or the like.

For example, the human-computer interface device 50 may further include the display. For example, the display may be a display of an audio, video, audio, video, navigation, and telematics (AVNT) system, a cluster, a head-up display (HUD), or a hologram projection display, and these display may be implemented as touchscreens, to output images.

According to an embodiment of the present disclosure, the controller 60 may include a target failure detection module 61, an emergency autonomous driving control module 62, a failure alarming module 63, a fused information collection module 64, a calculation module 65, a human-computer interaction determination module 66, and an execution module 67.

The controller 60 (particularly, the target failure detection module 61) may detect whether the steering force actuator (SFA) has failed. Particularly, an SFA target failure may mean a failure in which the RWA cannot detect the steering intention of the driver. For example, the SFA target failure may include a steering angle sensor failure, an SFA power failure or a communication failure between the SFA and a controller area network (CAN) bus, or the like.

Recently, some vehicle manufacturers may realize the safety protection of the SBW by employing two steering angle sensors and two SFA powers, and allowing the SFA to communicate with two CANs, and accordingly. Even in the case of the failure of the main CAN communication with respect to a main steering angle sensor or a main SFA power or the SFA, the backup CAN communication with respect to a backup steering angle sensor or a backup SFA power or the SFA may be used. In this case, the SFA target failure may include a failure of all of the main steering angle sensor and the backup steering angle sensor, a failure of all of the main SFA power and the backup SFA power, or a failure of communication between the SFA and both of the main CAN and the backup CAN.

In the case of a failure of the SBW system, that failed member or a SBW domain controller may generate a diagnostic trouble code (DTC).

During the process by the target failure detection module 61 detecting whether the SFA has failed, the target failure detection module 61 may receive the DTC. When the received DTC represents the SFA target failure, the target failure detection module 61 may detect the SFA target failure. In contrast, when the received DTC does not represent the SFA target failure, this may be a failure of other components such as the RWA of the SBW system, and the target failure detection module 61 may not detect the SFA target failure.

When the controller 60 detects the SFA target failure, the controller 60 may transmit an SFA failure message, by controlling the human-computer interaction interface device 50. Particularly, after the target failure detection module 61 detects the SFA target failure, the target failure detection module 61 may transmit the SFA failure signal to the human-computer interaction determination module 66. The human-computer interaction determination module 66 included in the controller 60 may transmit a control signal to the human-computer interaction interface device 50 (e.g., a display and a voice chatting AI assistant). After receiving the control signal, the display may display the SFA failure information, or voice chatting AI assistant may transmit a voice message such as “SFA failure”.

In addition to transmitting the SFA failure message to the driver located (or seated) inside the vehicle, the SFA failure message may be transmitted to other vehicles, pedestrians, and even vehicle maintenance personnel and/or accident rescue personnel, outside the vehicle. In particular, when the controller 60 detects the SFA target failure, the controller 60 may send an alarm primarily to the outside of the vehicle by controlling the failure alarming device 40. Particularly, when the target failure detection module 61 detects the SFA target failure, the target failure detection module 61 may transmit the SFA failure signal to the failure alarming module 63. As the failure alarming module 63 included in the controller 60 transmits a control signal to the vehicle illumination controller, the horn controller, and the failure information transmission module, the vehicle illumination controller may control the left-and-right signal lamp outside the vehicle to blink, the horn controller may control the horn to sound, and the failure information transmission module may transmit the failure information to the platform outside the vehicle. Therefore, the left-and-right signal lamp outside the vehicle can blink, the horn can sound, the occurrence of failure can be notified to the driver and other vehicles or pedestrians in the surroundings of the vehicle, and accident rescue personnel and/or vehicle maintenance personnel or the like can know the occurrence of the SFA failure of the vehicle through the platform outside the vehicle.

When the driver cannot manually steer the vehicle any more due to the SFA failure, the vehicle may need to enter the emergency autonomous driving mode, to secure safety. To this end, according to an embodiment of the present disclosure, when the SFA target failure is detected, the controller 60 may execute the LFA control and the FCA control using the emergency autonomous driving control device 30.

In more detail, when the SFA target failure is detected, the target failure detection module 61 may transmit the SFA failure signal to the emergency autonomous driving control module 62, and the emergency autonomous driving control module 62 may transmit a control signal to operate the LFA module and the FCA module to the LFA module and the FCA module included in the emergency autonomous driving control device 30. Therefore, by the operation of the LFA module and the FCA module, the vehicle can maintain the current driving lane during driving, and can execute an emergency braking when the forward collision risk exists, thereby securing the safety of the vehicle.

At this time, the vehicle manipulation may be converted from a driver manual manipulation to a vehicle autonomous driving. In the emergency autonomous driving mode of the vehicle, the driver's input of driving operation signal may be blocked. Particularly, by blocking the signal inputs of the brake pedal and the accelerator pedal, malfunctions due to excessive tension on the driver may be prevented and greater risks may be prevented from occurring. In particular, at this time, since the driver cannot control the vehicle speed by the accelerator pedal, and cannot stop the vehicle by the brake pedal, finding the time point for controlling the vehicle speed to stop the vehicle may become important.

According to an embodiment of the present disclosure, when the SFA target failure is detected, the controller 60 may determine a target speed of the vehicle based on information detected by the sensor 10 and control the acceleration/deceleration device 20 so that the vehicle drives at the target speed.

In more detail, when the SFA target failure is detected, the target failure detection module 61 may transmit the SFA failure signal to the fused information collection module 64. The fused information collection module 64 included in the controller 60 may receive the information of the vehicle and the information on the surroundings of the vehicle (these may become a fused detection information) from the sensor 10 (e.g., a speed sensor, the acceleration sensor, or a camera), transmit the received fused detection information to the calculation module 65, and the calculation module 65 of the controller 60 may calculate the target speed of the vehicle based on the received fused detection information.

As described above, the information of the vehicle may include the vehicle speed, and the information on the surroundings of the vehicle may include a speed of an object existing in the same lane as the vehicle and driving in front of the vehicle (hereinafter, referred to as a ‘front object’), a speed of an object existing in the same lane as the vehicle and driving in rear of the vehicle (hereinafter, referred to as a ‘rear object’), and a relative distances of the front object and the rear object with respect to the vehicle. In this way, the calculation module 65 may determine the target speed of the vehicle in consideration of the front object and the rear object.

In more detail, the calculation module 65 may determine whether a relative distance between the vehicle and the rear object is greater than or equal to a predetermined safety distance.

When the relative distance between the vehicle and the rear object is greater than or equal to the predetermined safety distance, the calculation module 65 may preliminarily (or preemptively) determine the target speed as a predetermined safety speed.

The safety speed may mean a minimum speed that can be selected by the driver without violating traffic regulations and while ensuring safe driving or a normal speed preferred by the driver or the occupant. In general, the safety speed relates to road sections. For example, road sections with different curvatures may be set with different safety speeds.

After considering the rear object, the front object needs to be further considered. After preliminarily (or preemptively) determining the target speed as the predetermined safety speed, the calculation module 65 may determine whether the predetermined safety speed is greater than a speed of the front object.

When the predetermined safety speed is smaller than or equal to the speed of the front object, the calculation module 65 may finally determine the target speed as the predetermined safety speed. In this case, a failed vehicle may not follow the front object while maintaining the distance to the rear object but maintain an appropriate distance to the front object and the rear object.

To the contrary, when the predetermined safety speed is greater than the speed of the front object, in order to avoid collision with the front object, the calculation module 65 may finally set the target speed of the vehicle to be smaller than or equal to the speed of the front object.

However, when the relative distance between the vehicle and the rear object is smaller than the predetermined safety distance, in order to avoid collision with the front and rear objects, the calculation module 65 may set the target speed of the vehicle to be greater than or equal to a speed of the rear object and smaller than or equal to the speed of the front object.

The calculation module 65 may transmit the calculated target speed to the execution module 67, and the execution module 67 included in the controller 60 may execute deceleration or acceleration operation by controlling the acceleration/deceleration device 20 based on the received target speed information. For example, the execution module 67 may transmit a control instruction to the BBW controller so that the BBW controller executes the deceleration operation of the vehicle, and when the vehicle speed is decelerated to the target speed as the execution module 67 may transmit the control instruction to the VCU, the VCU may maintain the vehicle speed at the target speed by controlling the vehicle power system.

However, the vehicle may not always drive at the target speed but need to find an appropriate time point to stop the vehicle. Therefore, according to an embodiment of the present disclosure, while the vehicle is driving at the target speed, the controller 60 may determine whether a stopping condition is satisfied based on information detected by a sensor, and when the stopping condition is satisfied, stops the vehicle by controlling the acceleration/deceleration device 20.

On the other hand, the vehicle may be stopped in the current driving lane, and the driver may get out of the vehicle and place a warning sign board behind the vehicle to alert rear objects. Alternatively, the vehicle may be stopped in the outermost lane of the current driving lane and does not interfere with a normal driving of other vehicles on the road in inner lanes.

When stopping the vehicle in the current driving lane, the vehicle stop may mean decreasing of the vehicle speed, and at this time, only the rear object may be considered without considering the front object. The controller 60 (particularly, the calculation module 65) may determine whether there exists an object approaching a rear side of the vehicle in a predetermined distance in a speed greater than a high-speed threshold. The high-speed threshold may mean the highest speed that the object can use without violating traffic regulations and while ensuring safe driving. The high-speed threshold may mean a speed exceeding the highest speed to cause unsafe driving and/or violation of traffic regulations. When the object approaching the rear side of the vehicle in the predetermined distance in the speed greater than the high-speed threshold does not exist, the calculation module 65 may determine that a condition for stopping the vehicle in the current driving lane is satisfied. For example, when there is no vehicle driving about 45 km/h or more within about 500 m in the rear of the vehicle, the condition for stopping the vehicle in the current driving lane is satisfied. In this case, the fused detection information that is used may include the relative distance between the nearby object and the vehicle and the speed of the nearby object.

When the vehicle is to stop in the outermost lane of the current driving lane, the current driving lane of the vehicle may not be the outermost lane. Therefore, the controller 60 (particularly, the calculation module 65) may determine whether the current driving lane of the vehicle is the outermost lane, and determine that a condition for stopping the vehicle in the outermost lane of the current driving lane is satisfied, when the current driving lane of the vehicle is not the outermost lane. In this case, the fused detection information that is used may include whether there is the shoulder or the roadside fence and the position relationship between the shoulder or the roadside fence and the current driving lane of the vehicle. When it is detected that the shoulder or the roadside fence exists, and the existing shoulder or roadside fence is not located on the right side of the current driving lane of the vehicle, may determine that the current driving lane of the vehicle is not the outermost lane.

When one condition of the condition for stopping the vehicle in the current driving lane and the condition for stopping the vehicle in the outermost lane of the current driving lane is satisfied, it may be determined that the stopping condition is satisfied.

According to an embodiment of the present disclosure, when the condition for stopping the vehicle in the current driving lane and the condition for stopping the vehicle in the outermost lane of the current driving lane is all satisfied, the controller 60 may output information to ask whether to stop the vehicle in the current driving lane or whether to stop the vehicle in the outermost lane of the current driving lane.

In more detail, the calculation module 65 may transmit a signal determining that the stopping conditions of two types (i.e., two stopping conditions of a condition for stopping in the outermost lane and a condition for stopping in the current lane) are all satisfied to the human-computer interaction determination module 66 included in the controller 60. In response to receiving the signal from the calculation module 65, the human-computer interaction determination module 66 may transmit a control signal to the human-computer interaction interface device 50 (e.g., a display and a voice chatting AI assistant). When the control signal is received, the display may display information such as “Will do stop in the current lane, or in the outermost lane?”, or the voice chatting AI assistant may transmit a voice message such as “Will you stop in the current lane, or in the outermost lane?”. In response thereto, the driver may select whether to stop the vehicle in the current lane or whether to stop the vehicle in the outermost lane, in the manner of speaking in voice or touching the display.

In an example, when the controller 60 (particularly, the human-computer interaction determination module 66) receives an instruction to stop the vehicle in the outermost lane of the current driving lane, this may mean that the driver has selected to stop the vehicle in the outermost lane. In another example, when only the condition for stopping the vehicle in the outermost lane of the current driving lane is satisfied, and the condition for stopping the vehicle in the current driving lane is not satisfied, each of these two examples may cause the vehicle to stop in the outermost lane of the current driving lane.

Since the vehicle needs to change the lane from the current driving lane to the outermost lane, the LFA module, which is already operating to maintain the vehicle in the current driving lane, needs to be turned off. To this end, the controller 60 may turn off the LFA control of the emergency autonomous driving control device 30.

In more detail, the human-computer interaction determination module 66 may transmit a signal of the driver's selecting to stop the vehicle in the outermost lane to the emergency autonomous driving control module 62, and when the signal is received, the emergency autonomous driving control module 62 may transmit a control signal to turn off the LFA module.

Alternatively, the calculation module 65 may transmit a signal satisfying only the condition for stopping in the outermost lane to the emergency autonomous driving control module 62, and when the signal is received, the emergency autonomous driving control module 62 may transmit a control signal to turn off the LFA module. The calculation module 65 may further transmit the signal satisfying only the condition for stopping in the outermost lane to the human-computer interaction determination module 66, and when the signal is received, the human-computer interaction determination module 66 may notify the driver that the vehicle is to stop in the outermost lane by controlling the human-computer interaction interface device 50. For example, the display may display information such as “Possible to stop in the outermost lane, which is being executed”, or the voice chatting AI assistant may transmit a voice message such as “Possible to stop in the outermost lane, which is being executed”.

In addition, the controller 60 may turn on the ALC control of the emergency autonomous driving control device 30. Particularly, when the signal of the driver's selection to stop the vehicle in the outermost lane is received, the emergency autonomous driving control module 62 may transmit a control signal to turn on the ALC module. Alternatively, when the signal satisfying only the condition for stopping in the outermost lane is received, the emergency autonomous driving control module 62 may transmit a control signal to turn on the ALC module.

Based on information detected by the sensor 10, the controller 60 may control the lane change to be executed at least once using the ALC module, to change the lane of the vehicle to the outermost lane. At this time, the used fused detection information may include, at least, the position of the current driving lane of the vehicle, the position relationship between the existing shoulder or roadside fence and the current driving lane of the vehicle, and the relative distance and relative speed between the nearby object and the vehicle, or the like. For example, when one road has eight lanes, a first lane, a second lane, a third lane, and a fourth lanes may be designated as a first driving direction, and a fifth lane, a sixth lane, a seventh lane, and an eight lane may be designated as a second driving direction that is opposite thereto. When it is detected by the sensor 10 (particularly, a camera) that the vehicle is driving in a fifth lane, the shoulder or the roadside fence may exist on the right side of the eight lanes, the controller may need to execute the lane change three times using the ALC module and to change the lane of the vehicle to the outermost lane (i.e., eight lanes).

In addition, while changing the lane, the emergency autonomous driving control module 62 may control on and off of the ALC module based on the relative distance and relative speed between the nearby object and the vehicle. For example, when there is a collision risk with respect to the rear object in the lane change of the vehicle, an emergency autonomous driving control module 61 may temporarily turn off the ALC control, and when the collision risk is resolved, it may maintain turning on of the ALC control.

The vehicle may lane-change to a location close to the shoulder or the roadside fence of the outermost lane rather than to a location in the middle of the outermost lane.

When the lane of the vehicle is changed to the outermost lane of the current driving lane, the controller stops the vehicle by controlling the acceleration/deceleration device 20. Particularly, the emergency autonomous driving control module 61 may transmit a signal indicating that a lane change of the vehicle has been completed to the execution module 67. For example, when the signal indicating that the lane change of the vehicle has been completed is received, the execution module 67 may transmit the control instruction to the BBW controller, so that the BBW controller executes the deceleration operation of the vehicle until the vehicle speed becomes about 0.

For example, when the controller 60 (particularly, the human-computer interaction determination module 66) receives an instruction to stop the vehicle in the current driving lane, this may mean that the driver has selected to stop the vehicle in the current lane. In another example, when only the condition for stopping the vehicle in the current driving lane is satisfied, and the condition for stopping the vehicle in the outermost lane of the current driving lane is not satisfied, in both of the two examples, the vehicle may be caused to stop in the current driving lane.

In the previous two examples, the controller 60 may stop the vehicle by controlling (or directly controlling) the acceleration/deceleration device 20 even without turning off the LFA module or turning on the ALC module.

The human-computer interaction determination module 66 may transmit a signal of the driver's selecting to stop the vehicle in the current lane to the execution module 67.

Alternatively, the calculation module 65 may transmit a signal satisfying only the condition for stopping in the current lane to the execution module 67. The calculation module 65 may further transmit the signal satisfying only the condition for stopping in the current lane to the human-computer interaction determination module 66, and when the signal is received, the human-computer interaction determination module 66 may notify the driver that the vehicle is to stop in the current lane by controlling the human-computer interaction interface device 50. For example, the display may display information such as “Possible to stop in the current lane, which is being executed”, or the voice chatting AI assistant may transmit a voice message such as “Possible to stop in the current lane, which is being executed”.

For example, when the signal of the driver's selecting to stop the vehicle in the current lane or the signal satisfying only the condition for stopping in the current lane is received, the execution module 67 may transmit the control instruction to the BBW controller, so that the BBW controller executes the deceleration operation of the vehicle until the vehicle speed becomes about 0.

When the vehicle stops, the fused information collection module 64 may receive information that the vehicle speed is 0 from the vehicle speed sensor. The fused information collection module 64 may transmit a vehicle stop signal to the human-computer interaction determination module 66, and when the vehicle stop signal is received, the human-computer interaction determination module 66 may transmit a message to exit the vehicle by controlling the human-computer interaction interface device 50. For example, the display may display information such as “Please exit the vehicle and wait in a safe area”, or the voice chatting AI assistant may transmit a voice message such as “Please exit the vehicle and wait in a safe area”, thereby minimizing risk by warning the driver and the vehicle occupants to evacuate to a safe area and wait for rescue.

In addition, the fused information collection module 64 may transmit the vehicle stop signal to the failure alarming module 63, and the failure alarming module 63 may control the failure information transmission module to transmit the failure information and the location of the failed vehicle to the platform outside the vehicle. Therefore, accident rescue personnel and/or vehicle maintenance personnel or the like may notice the vehicle failure through the platform outside the vehicle, and move to the location of the failed vehicle to proceed a rescue operation.

In an embodiment of the present disclosure, the controller 60 may be implemented through an electronic control unit (ECU), and communication may be performed between the controller 60 and each member (i.e., the sensor 10, the acceleration/deceleration device 20, the emergency autonomous driving control device 30, the failure alarming device 40, the human-computer interaction interface device 50), through the CAN bus.

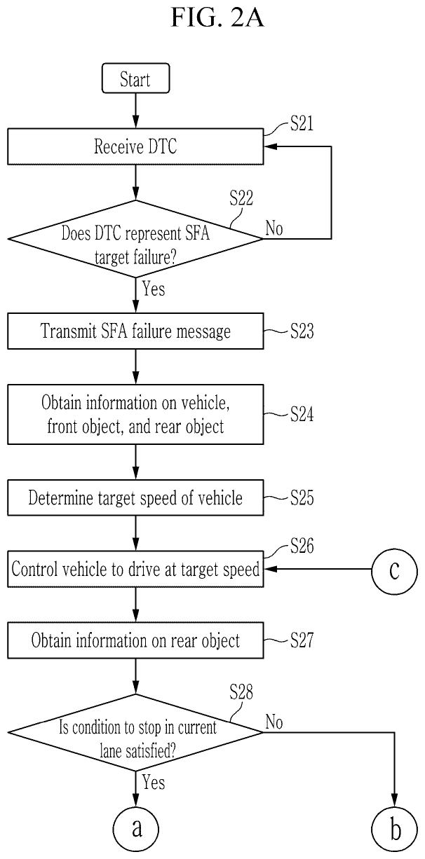

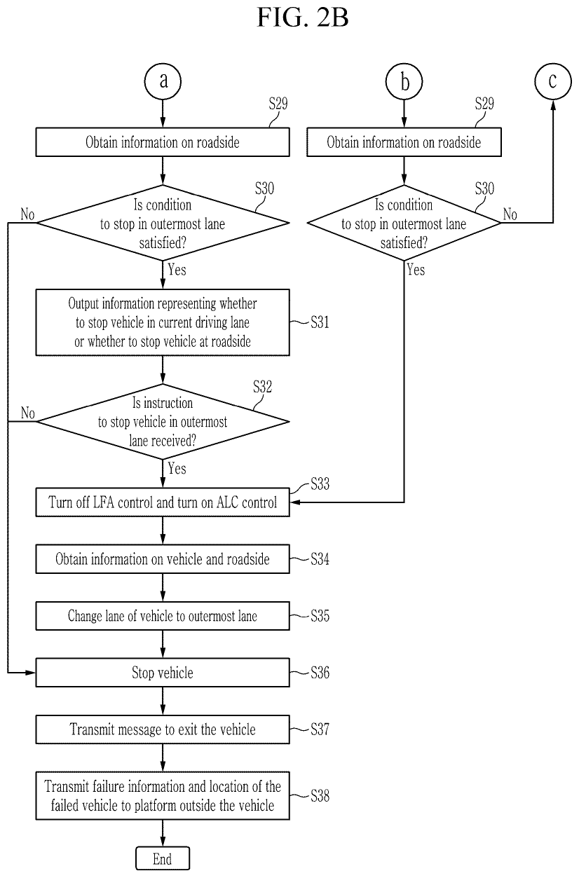

FIG. 2A and FIG. 2B are schematic flowcharts of an emergency control method in the case of a failure of an SBW system according to an embodiment of the present disclosure.

As shown in FIG. 2A and FIG. 2B, an emergency control method in the case of a failure of an SBW system according to an embodiment of the present disclosure may include a step S21 of receiving the DTC. A step S22 of determining whether the received DTC represents the SFA target failure may be included. Particularly, the SFA target failure may include the steering angle sensor failure, the SFA power failure, or the communication failure between the SFA and the CAN bus, or the like.

When the received DTC represents the SFA target failure (step S22—Yes), this may mean that the SFA target failure is detected. In this case, by transmitting the SFA failure message, at step S23, the driver inside the vehicle is notified, and pedestrians and other vehicles in the surroundings of the vehicle may be alerted by sending an alarm to the outside of the vehicle.

According to an embodiment of the present disclosure, the information of the vehicle may include speed and acceleration of the vehicle, and the position of the current driving lane of the vehicle, and the information on the surroundings of the vehicle may include the relative distance and relative speed between the nearby object and the vehicle, the positions of lanes and the number of lanes on the road, the speed limit of the road, whether there is the shoulder or the roadside fence and the position relationship between the shoulder or the roadside fence and the current driving lane of the vehicle.

The vehicle speed, the speed of the front object, the speed of the rear object, and the relative distances of the front object and the rear object with respect to the vehicle may be obtained at step S24, and the target speed of the vehicle based on the fused detection information may be determined at step S25.

In more detail, the step S25 of determining the target speed of the vehicle may include a step of determining whether the relative distance between the vehicle and the rear object is greater than or equal to the predetermined safety distance. When the relative distance between the vehicle and the rear object is greater than or equal to the predetermined safety distance, the target speed may be preliminarily (or preemptively) determined as the predetermined safety speed. Whether the predetermined safety speed is greater than the speed of the front object may be determined. When the predetermined safety speed is smaller than or equal to the speed of the front object, the target speed may be finally determined as the predetermined safety speed. However, when the predetermined safety speed is greater than the speed of the front object, the target speed may be finally set to be smaller than or equal to the speed of the front object. When the relative distance between the vehicle and the rear object is smaller than the predetermined safety distance, the vehicle the target speed may be set to be greater than or equal to the speed of the rear object and smaller than or equal to the speed of the front object.

When the target speed is determined, the vehicle may be controlled to drive at the target speed at step S26.

While the vehicle is driving at the target speed, the relative distance between the rear object and the vehicle and the speed of the rear object are obtained at step S27, and whether the condition for stopping the vehicle in the current driving lane is satisfied is determined according to the fused detection information at step S28.

In more detail, the step S28 of determining whether the condition for stopping the vehicle in the current driving lane is satisfied may determine whether there exists the object approaching the rear side of the vehicle in the predetermined distance in the speed greater than the high-speed threshold, and when the object approaching the rear side of the vehicle in the predetermined distance in the speed greater than the high-speed threshold does not exist, determine that the condition for stopping the vehicle in the current driving lane may be satisfied.

In addition, while the vehicle is driving at the target speed, whether there is the shoulder or the roadside fence and the position relationship between the shoulder or the roadside fence and the current driving lane of the vehicle is obtained, at step S29, and whether the condition for stopping the vehicle in the outermost lane of the current driving lane is satisfied based on the fused detection information may be determined at step S30.

When the one condition of the condition for stopping the vehicle in the current driving lane and the condition for stopping the vehicle in the outermost lane of the current driving lane is satisfied, it may be determined that the stopping condition is satisfied. At this time, three cases may occur, in which particularly, a first case may mean the case in which the condition for stopping the vehicle in the current driving lane may be satisfied (step S28—Yes) and the condition for stopping the vehicle in the outermost lane of the current driving lane is also satisfied (step S30—Yes), a second case may mean the case in which the condition for stopping the vehicle in the current driving lane may be satisfied (step S28—Yes) but the condition for stopping the vehicle in the outermost lane of the current driving lane is not satisfied (step S30—No), and a third case may mean the case in which the condition for stopping the vehicle in the current driving lane is not satisfied (step S28—No) but the condition for stopping the vehicle in the outermost lane of the current driving lane is satisfied (step S30—Yes). Hereinafter, vehicle control methods in these three cases will be described in detail.

When the condition for stopping the vehicle in the current driving lane is satisfied (step S28—Yes) and the condition for stopping the vehicle in the outermost lane of the current driving lane is also satisfied (step S30—Yes), information to ask whether to stop the vehicle in the current driving lane or whether to stop the vehicle in the outermost lane of the current driving lane may be output at step S31, to obtain the control instruction of the driver selecting the stopping in the current lane or the stopping in the outermost lane by interacting with the driver.

Whether the instruction to stop the vehicle in the outermost lane of the current driving lane is received may be determined at step S32, in particular, whether the driver has selected the stopping in the outermost lane is determined.

When the instruction to stop the vehicle in the outermost lane of the current driving lane is received (step S32—Yes), the LFA control may be turned off and the ALC control may be turned on at step S33.

The position of the current driving lane of the vehicle, the position relationship between the existing shoulder or roadside fence and the current driving lane of the vehicle, and the relative distance and relative speed between the nearby object and the vehicle, or the like, may be obtained at step S34. By performing the lane change of the vehicle once or more time using a lane change assist control based on the fused detection information, the lane of the vehicle may be changed to the outermost lane at step S35. After the vehicle changes the lane to the outermost lane, the vehicle stopping operation may be executed at step S36.

When the instruction to stop the vehicle in the outermost lane of the current driving lane is not received, but the instruction to stop the vehicle in the current driving lane may be received (step S32—No), the vehicle stopping operation may be executed at the step S36. In particular, the vehicle does not change the lane and stops in the current driving lane.

When the condition for stopping the vehicle in the current driving lane is satisfied (step S28—Yes) and the condition for stopping the vehicle in the outermost lane of the current driving lane is not satisfy (step S30—No), the step S36 may be executed. In particular, the vehicle may be stopped in the current driving lane.

When the condition for stopping the vehicle in the current driving lane is not satisfied (step S28—No) and the condition for stopping the vehicle in the outermost lane of the current driving lane is satisfied (step S30—No), the step S33 to the step S36 may be executed to change the lane of the vehicle to the outermost lane and then stop the vehicle.

After the vehicle stops, by transmitting a message to exit the vehicle, at step S37, risk may be minimized by warning the driver and the vehicle occupants to evacuate to a safe area and wait for rescue. In addition, by further transmitting the failure information and the location of the failed vehicle to the platform outside the vehicle, at step S38 accident rescue personnel and/or vehicle maintenance personnel or the like can notice the vehicle failure through the platform outside the vehicle and move to the location of the failed vehicle to perform the rescue operation.

In summary, an embodiment of the present disclosure provides a vehicle emergency control system and emergency control method in the case of a failure of a SBW system (particularly, SFA). The emergency control system may include the target failure detection module, the emergency assistant driving control module, the failure alarming module, the fused information collection module, the calculation module, the human-computer interaction determination module, and the execution module, and the modules communicate with each other through the CAN bus. The system may read fault diagnosis information of the vehicle, detect the SFA failure in which the RWA cannot detect the steering intention of the driver, perform control so that the vehicle enters an emergency assistant driving control mode, and at the same time, control a vehicle-installed AI voice chatting assistant to send a failure alarm to the driver and the outside of the vehicle. The system may determine the target speed based on the detected information and control an acceleration/deceleration device so that the vehicle drives at the target speed. The system may determine whether the stopping condition is satisfied based on the fused detection information, perform human-computer interaction with the driver through the human-computer interaction determination module, and then execute the stopping in the current lane or the stopping in the roadside based on the control instruction of the driver. After having stopped, the system may notify the driver to evacuate to a safe location and wait for rescue, execute a control strategy minimizing risk by controlling the vehicle, and control a data transmission system to transmit the vehicle failure information and location information to vehicle maintenance personnel and accident rescue personnel. In the case of the SFA failure, an embodiment of the present disclosure may control the vehicle to safely decelerate based on the vehicle and environment sensing information, and improve the driving safety by effectively reducing the safety accidents of the vehicle by executing the stopping operation based on the control instruction of the driver.

When the driver cannot manually steer the vehicle due to the SFA target failure, an emergency control system in case of a failure of an SBW system and emergency control method according to an embodiment of the present disclosure can convert the vehicle into the emergency autonomous driving mode, determined a vehicle driving safety speed, and find an appropriate time point and stop the vehicle. After the vehicle stops, the driver and the vehicle occupants may be warned to evacuate to a safe area and wait for rescue, and the failure information and the location of the failed vehicle may be notified to accident rescue personnel and/or vehicle maintenance personnel.

According to an embodiment of the present disclosure, when the driver cannot manually operate the vehicle steering any more due to due to an SFA failure, the vehicle can be controlled to safely decelerate, and the driving safety can be improved by effectively reducing the safety accidents of the vehicle by executing the stopping operation based on the control instruction of the driver.

In addition, after the vehicle stops, it can warn the driver and the vehicle occupants to evacuate to a safe area and wait for rescue and can notify failure information and a location of a failed vehicle to accident rescue personnel and/or vehicle maintenance personnel.

The various embodiments of the present disclosure are not a complete list of all possible combinations, but are intended to illustrate representative aspects of the present disclosure, and the descriptions of various embodiments may be applied independently or in combination of two or more.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

What is claimed is:

1. An emergency control system for a vehicle, the emergency system being configured to operate in response to a failure of a steer-by-wire (SBW) system of the vehicle,
wherein the SBW system includes a steering force actuator connected to a steering wheel and a wheel drive and performs communication between the steering force actuator and the wheel drive to control wheel steering through the steering wheel,
wherein the emergency control system comprises:
at least one sensor configured to detect information relating to the vehicle and information on surroundings of the vehicle;
an acceleration/deceleration device configured to control a vehicle speed;
an emergency autonomous driving control device configured to execute a vehicle lane change assist control, a lane following assist control, and a forward collision-avoidance assist control; and
a controller, and
wherein the controller is configured to:
execute the lane following assist control and the forward collision-avoidance assist control using the emergency autonomous driving control device, when a target failure of the steering force actuator is detected;
determine a target speed of the vehicle based on the information detected by the at least one sensor and control the acceleration/deceleration device so that the vehicle drives at the target speed;
determine whether a stopping condition is satisfied based on the information detected by the at least one sensor; and
control the acceleration/deceleration device, when the stopping condition is satisfied.

2. The emergency control system of claim 1, wherein the controller is configured to:
determine whether a relative distance between the vehicle and a rear object is greater than or equal to a predetermined safety distance, while determining the target speed of the vehicle;
preemptively determine the target speed as a predetermined safety speed, when the relative distance between the vehicle and the rear object is greater than or equal to the predetermined safety distance;
determine whether the predetermined safety speed is greater than a speed of a front object;
finally determine the target speed as the predetermined safety speed, when the predetermined safety speed is smaller than or equal to the speed of the front object;
finally set the target speed to be smaller than or equal to the speed of the front object, when the predetermined safety speed is greater than the speed of the front object; and
set the target speed of the vehicle to be greater than or equal to a speed of the rear object and smaller than or equal to the speed of the front object, when the relative distance between the vehicle and the rear object is smaller than the predetermined safety distance.

3. The emergency control system of claim 1, wherein the controller is configured to:
determine whether an object approaching a rear side of the vehicle in a predetermined distance in a speed is greater than a high-speed threshold, while determining whether the stopping condition is satisfied, and determine that a condition for stopping the vehicle in a current driving lane is satisfied, when the object approaching the rear side of the vehicle in the predetermined distance in the speed greater than the high-speed threshold does not exist;
determine whether the current driving lane of the vehicle is an outermost lane, and determine that a condition for stopping the vehicle in the outermost lane of the current driving lane is satisfied, when the current driving lane of the vehicle is not the outermost lane; and
determine that the stopping condition is satisfied, when one condition of the condition for stopping the vehicle in the current driving lane and the condition for stopping the vehicle in the outermost lane of the current driving lane is satisfied.

4. The emergency control system of claim 3, wherein the controller is configured to:
output information to ask whether to stop the vehicle in the current driving lane or whether to stop the vehicle in the outermost lane of the current driving lane, when the condition for stopping the vehicle in the current driving lane and the condition for stopping the vehicle in the outermost lane of the current driving lane is all satisfied;
turn off the lane following assist control of the emergency autonomous driving control device, turn on the vehicle lane change assist control, perform a lane change of the vehicle once or more time using the lane change assist control based on the information detected by the at least one sensor, and stop the vehicle by controlling the acceleration/deceleration device after the vehicle has lane-changed to the outermost lane, when an instruction to stop the vehicle in the outermost lane of the current driving lane is received, or when only the condition for stopping the vehicle in the outermost lane of the current driving lane is satisfied; and
stop the vehicle in the current driving lane by controlling the acceleration/deceleration device, when an instruction to stop the vehicle in the current driving lane is received, or when the condition for stopping the vehicle in the current driving lane is satisfied.

5. The emergency control system of claim 2, wherein the information of the vehicle includes speed and acceleration of the vehicle, and a position of a current driving lane of the vehicle.

6. The emergency control system of claim 2, wherein the information on the surroundings of the vehicle includes a relative distance and relative speed between a nearby object and the vehicle, positions of lanes, a number of lanes on a road, and a speed limit of the road, and
wherein the information on the surroundings of the vehicle further includes whether there is a shoulder or a roadside fence and a position relationship between the shoulder or the roadside fence and a current driving lane of the vehicle.

7. The emergency control system of claim 1, wherein the target failure of the steering force actuator includes at least a steering angle sensor failure, a steering force actuator power failure, and a communication failure between the steering force actuator and a CAN bus.

8. The emergency control system of claim 7, wherein the controller is configured to detect the target failure of the steering force actuator, when a diagnostic trouble code is received from the SBW system, and the received diagnostic trouble code represents a steering force actuator failure, while detecting the target failure of the steering force actuator.

9. The emergency control system of claim 1, further comprising a failure alarming device,
wherein the controller is configured to send an alarm to a driver and an outside of the vehicle by controlling the failure alarming device, when the target failure of the steering force actuator is detected.

10. The emergency control system of claim 1, further comprising a human-computer interaction interface device,
wherein the controller is configured to:
transmit a steering force actuator failure message by controlling the human-computer interaction interface device, when the target failure of the steering force actuator is detected;
obtain a control instruction of a driver by controlling the human-computer interaction interface device, when it is determined that a condition for stopping the vehicle in a current driving lane and a condition for stopping the vehicle in an outermost lane of the current driving lane are all satisfied; and
transmit a message to exit the vehicle by controlling the human-computer interaction interface device, when the vehicle stops.

11. An emergency control method for a vehicle, the emergency system being configured to operate in response to a failure of a steer-by-wire (SBW) system of the vehicle, wherein the SBW system includes a steering force actuator connected to a steering wheel and a wheel drive and performs communication between the steering force actuator and the wheel drive to control wheel steering through the steering wheel, the emergency control method includes:
executing a lane following assist control and a forward collision-avoidance assist control, when a target failure of the steering force actuator is detected;
determining a target speed of the vehicle based on information of the vehicle and information on surroundings of the vehicle;
controlling the vehicle to drive at the target speed;
determining whether a stopping condition is satisfied based on the information of the vehicle and the information on the surroundings of the vehicle; and
executing a vehicle stopping operation, when the stopping condition is satisfied.

12. The emergency control method of claim 11, wherein the determining of the target speed of the vehicle includes:
determining whether a relative distance between the vehicle and a rear object is greater than or equal to a predetermined safety distance;
preemptively determining the target speed as a predetermined safety speed, when the relative distance between the vehicle and the rear object is greater than or equal to the predetermined safety distance;
determining whether the predetermined safety speed is greater than a speed of a front object;
finally determining the target speed as the predetermined safety speed, when the predetermined safety speed is smaller than or equal to the speed of the front object;
finally setting the target speed to be smaller than or equal to the speed of the front object, when the predetermined safety speed is greater than the speed of the front object; and
setting the target speed of the vehicle to be greater than or equal to a speed of the rear object and smaller than or equal to the speed of the front object, when the relative distance between the vehicle and the rear object is smaller than the predetermined safety distance.

13. The emergency control method of claim 11, wherein the determining of whether the stopping condition is satisfied includes:
determining whether an object approaching a rear side of the vehicle in a predetermined distance in a speed is greater than a high-speed threshold, and determining whether a current driving lane of the vehicle is an outermost lane;
determining that a condition for stopping the vehicle in the current driving lane is satisfied, when the object approaching the rear side of the vehicle in the predetermined distance in the speed greater than the high-speed threshold does not exist;
determining that a condition for stopping the vehicle in the outermost lane of the current driving lane is satisfied, when the current driving lane of the vehicle is not the outermost lane; and
determining that the stopping condition is satisfied, when one condition of the condition for stopping the vehicle in the current driving lane and the condition for stopping the vehicle in the outermost lane of the current driving lane is satisfied.

14. The emergency control method of claim 13, wherein the executing of the stopping operation of the vehicle includes:
outputting information to ask whether to stop the vehicle in the current driving lane or whether to stop the vehicle in the outermost lane of the current driving lane, when the condition for stopping the vehicle in the current driving lane and the condition for stopping the vehicle in the outermost lane of the current driving lane is all satisfied;
turning off the lane following assist control, turning on a lane change assist control, performing a lane change of the vehicle once or more time using the lane change assist control based on the information of the vehicle and the information on the surroundings of the vehicle, and stopping the vehicle after the vehicle has lane-changed to the outermost lane, when an instruction to stop the vehicle in the outermost lane of the current driving lane is received, or when only the condition for stopping the vehicle in the outermost lane of the current driving lane is satisfied; and
stopping the vehicle in the current driving lane, when an instruction to stop the vehicle in the current driving lane is received, or when only the condition for stopping the vehicle in the current driving lane is satisfied.

15. The emergency control method of claim 12, wherein the information of the vehicle includes speed and acceleration of the vehicle, and a position of a current driving lane of the vehicle.

16. The emergency control method of claim 12, wherein the information on the surroundings of the vehicle includes a relative distance and relative speed between a nearby object and the vehicle, positions of lanes, a number of lanes on a road, and a speed limit of the road, and
wherein the information on the surroundings of the vehicle further includes whether there is a shoulder or a roadside fence and a position relationship between the shoulder or the roadside fence and a current driving lane of the vehicle.

17. The emergency control method of claim 11, wherein the target failure of the steering force actuator includes at least a steering angle sensor failure, a steering force actuator power failure, and a communication failure between the steering force actuator and a CAN bus.

18. The emergency control method of claim 17, wherein the detecting of the target failure of the steering force actuator includes:
detecting the target failure of the steering force actuator, when a diagnostic trouble code is received and the received diagnostic trouble code represents a steering force actuator failure.

19. The emergency control method of claim 11, further comprising sending an alarm to a driver and an outside of the vehicle, when the target failure of the steering force actuator is detected.

20. The emergency control method of claim 19, further comprising:
transmitting a steering force actuator failure message, when the target failure of the steering force actuator is detected;
obtaining a control instruction of the driver, when it is determined that a condition for stopping the vehicle in a current driving lane and a condition for stopping the vehicle in an outermost lane of the current driving lane are all satisfied; and
transmitting a message to exit the vehicle, when the vehicle stops.
